(19) United States
(12) Patent Application Publication
(10) Pub. No.: US 2016/0094748 A1
(43) Pub. Date: Mar. 31, 2016

(54) INFORMATION PROCESSING SYSTEM, IMAGE PROCESSING APPARATUS AND INFORMATION PROCESSING METHOD

(71) Applicant: Yohsuke UTOH, Kanagawa (JP)

(72) Inventor: Yohsuke UTOH, Kanagawa (JP)

(73) Assignee: RICOH COMPANY, LTD., Tokyo (JP)

(21) Appl. No.: 14/838,624

(22) Filed: Aug. 28, 2015

(30) Foreign Application Priority Data
Sep. 29, 2014 (JP) 2014-198512

(51) Int. Cl. H04N 1/00

(52) U.S. Cl. CPC H04N 1/00896; H04N 1/00915; H04N 1/00933; H04N 1/0097; H04N 2201/0094

(57) ABSTRACT

An information processing system includes plural image processing apparatuses which are connected with each other via a network. The information processing system further includes a human detection unit configured to detect a person within a predetermined range from an image processing apparatus of the plural image processing apparatuses; a process determination unit configured to determine whether the image processing apparatus is performing execution of a predetermined process, in a case where the human detection unit detects the person; and a state transition unit configured to require another image processing apparatus of the plural image processing apparatuses, which is different from the image processing apparatus, to cause an operation state of the other image processing apparatus to transition to a state in which the predetermined process can be executed, in a case where the process determination unit determines that the image processing apparatus is performing execution of the predetermined process.

### BACKGROUND OF THE INVENTION

1. Field of the Invention

The disclosures herein generally relate to an information processing system, an image processing apparatus and an information processing method.

2. Description of the Related Art

Conventionally, there is known a technique that in an environment where plural image forming apparatuses exist, in a case where an image forming apparatus which a user desires to use is in use, another image forming apparatus which is not in use is reported to the user (See, for example, Japanese Patent Application No. 2002-273987).

However, in the above-described related-art, in a case where, for example, the other image forming apparatus is in a power saving mode, the user has to wait for recovery from power saving in order to use the other image forming apparatus.

### SUMMARY OF THE INVENTION

It is a general object of at least one embodiment of the present invention to provide an information processing system, an image processing apparatus and an information processing method that substantially obviate one or more problems caused by the limitations and disadvantages of the related art.

In one embodiment, an information processing system includes a plurality of image processing apparatuses which are connected with each other via a network. The information processing system further includes a human detection unit configured to detect a person within a predetermined range from an image processing apparatus of the plurality of image processing apparatuses; a process determination unit configured to determine whether the image processing apparatus is executing a predetermined process, in a case where the human detection unit detects the person within the predetermined range; and a state transition unit configured to require another image processing apparatus of the plurality of image processing apparatuses, which is different from the image processing apparatus, to cause an operation state of the other image processing apparatus to transition to a state in which the predetermined process can be executed, in a case where the process determination unit determines that the image processing apparatus is executing the predetermined process.

In another embodiment, an image processing apparatus is connected with another image processing apparatus via a network. The image processing apparatus includes a human detection unit configured to detect a person within a predetermined range from the image processing apparatus; a process determination unit configured to determine whether the image processing apparatus is executing a predetermined process, in a case where the human detection unit detects the person within the predetermined range; and a state transition unit configured to require the other image processing apparatus to cause an operation state of the other image processing apparatus to transition to a state in which the predetermined process can be executed, in a case where the process determination unit determines that the image processing apparatus is executing the predetermined process.

In yet another embodiment, an information processing method in an image processing apparatus connected with another image processing apparatus via a network includes detecting a person within a predetermined range from the image processing apparatus; determining whether the image processing apparatus is executing a predetermined process, in a case where the person is detected within the predetermined range; and requiring the other image processing apparatus to cause an operation state of the other image processing apparatus to transition to a state in which the predetermined process can be executed, in a case where the image processing apparatus is determined to be executing the predetermined process.

According to the embodiment of the present application, reduction of wait time till when the apparatus becomes a state where processes are executable can be supported.

### BRIEF DESCRIPTION OF THE DRAWINGS

Other objects and further features of embodiments will be apparent from the following detailed description when read in conjunction with the accompanying drawings, in which:

FIG. 1 is a diagram illustrating an example of a system configuration of an image processing system according to a first embodiment;

FIG. 2 is a diagram illustrating an example of a hardware configuration of an image forming apparatus according to the first embodiment;

FIG. 3 is a functional block diagram illustrating an example of the image forming apparatus according to the first embodiment;

FIG. 4 is a diagram for explaining an example of information on recovery destination from power saving according to the first embodiment;

FIG. 5 is a sequence diagram illustrating an example of a recovery process from power saving according to the first embodiment;

FIG. 6 is a functional block diagram illustrating an example of an image forming apparatus according to a second embodiment;

FIG. 7 is a diagram for explaining an example of power saving recovered information according to the second embodiment; and

FIG. 8 is a sequence diagram illustrating an example of a recovery process from power saving according to the second embodiment.

### DESCRIPTION OF THE PREFERRED EMBODIMENTS

In the following, embodiments of the present invention will be described with reference to the accompanying drawings.

### First Embodiment

<System Configuration>

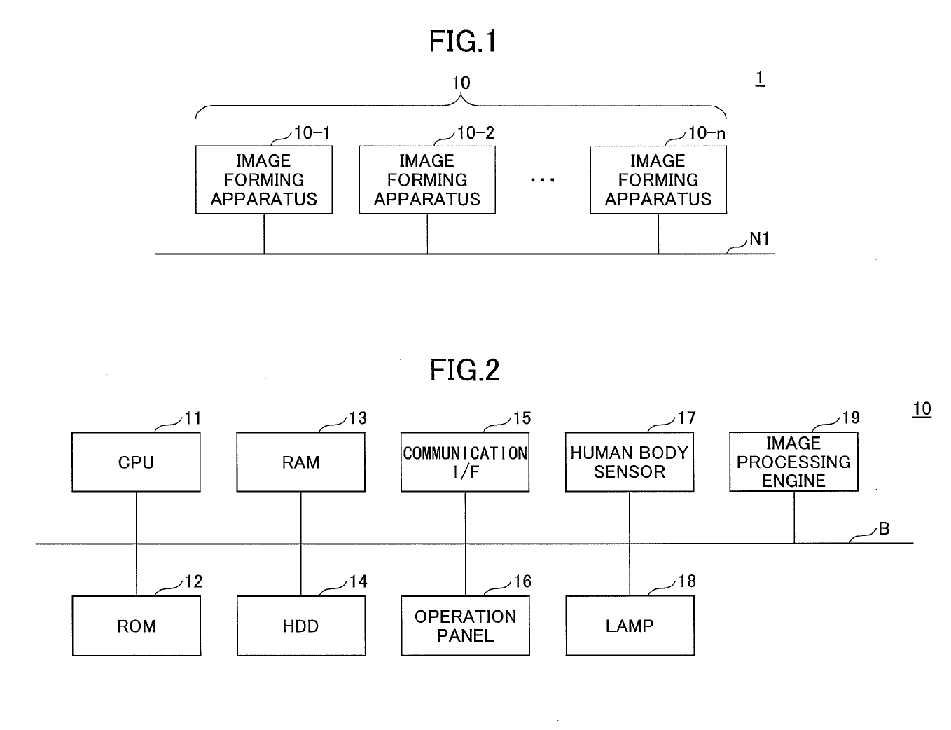

At first, a system configuration of an image processing system 1 according to a first embodiment will be explained. FIG. 1 is a system configuration diagram illustrating an example of the image processing system according to the first embodiment. The image processing system 1 shown in FIG. 1 is an example of an information processing system, and includes plural image forming apparatuses 10. Moreover, the plural image forming apparatuses 10 included in the image processing system 1 are connected with each other via a network N1, such as a LAN (Local Area Network), for example.

The image forming apparatus 10 is an example of an image processing apparatus, and is, for example, a MFP (MultiFunctional Peripheral) having plural functions, such as a printing function, a copying function, a scanning function and a facsimile function, or the like. However, the image processing apparatus is not limited to the image forming apparatus 10, but may be various electronic devices, such as a printer, a scanner, a projector, an electronic blackboard, digital signage or a gaming machine, for example. That is, the embodiments of the present invention can be applied to an information processing system having various electronic devices performing processes, which will be described later, by using a human body sensor.

Meanwhile, in a case of distinguishing each of the image forming apparatuses 10 included in the image processing system 1 according to the first embodiment, respective image forming apparatuses will be indicated by “image forming apparatus 10-1”, “image forming apparatus 10-2”, . . . , and “image forming apparatus 10-n”.

<Hardware Configuration>

Next, a hardware configuration of the image forming apparatus 10 according to the first embodiment will be explained. The image forming apparatus 10 according to the first embodiment is realized according to the hardware configuration as shown in FIG. 2, for example. FIG. 2 is a hardware configuration diagram illustrating an example of the image forming apparatus 10 according to the first embodiment. As shown in FIG. 2, the image forming apparatus 10 according to the first embodiment includes a CPU (Central Processing Unit) 11, a ROM (Read-Only Memory) 12, a RAM (Random Access Memory) 13, a HDD (Hard Disk Drive) 14, a communication I/F 15, an operation panel 16, a human body sensor 17, a lamp 18, an image processing engine 19 and the like, which are connected via a bus B to each other.

The CPU 11 is an arithmetic device that realizes control or function of the whole image forming apparatus 10 by reading out a program or data from a storage device, such as the ROM 12 or the HDD 14, onto the RAM 13, and executing processes.

The ROM 12 is a non-volatile semiconductor memory (storage device) that can retain a program or data even if power is turned off. The RAM 13 is a volatile semiconductor memory (storage device) that retains temporarily a program or data.

The HDD 14 is a non-volatile storage device that stores a program or data. The program or data stored in the HDD 14 includes, for example, an OS (Operating System) which is basic software controlling the whole image forming apparatus 10, application software that provides various functions on the OS, or the like. The HDD 14 manages the program or data stored in the HDD 14 by a predetermined file system and/or a DB (database). Meanwhile, the image forming apparatus 10 may be provided with a SSD (Solid State Drive) or the like instead of the HDD or in conjunction with the HDD.

The communication I/F 15 is an interface for connecting to a network by LAN or the like, for example. According to the above-described configuration, the image forming apparatus 10 can perform data communication with other image forming apparatuses 10 via the communication I/F 15.

The operation panel 16 is a touch panel that includes an input unit for receiving an input by a user and a display unit for performing displaying. The user can perform various input operations on the image forming apparatus 10 via the operation panel 16.

The human body sensor 17 is a sensor that detects a human being (person) around the image forming apparatus 10 (for example, a predetermined range in a front face direction of the operation panel 16 of the image forming apparatus 10). The human body sensor 17 is a sensor that detects a person using infrared light, ultrasonic waves, or visible light; for example, a sensor that detects a person by using image data generated by capturing by a camera, or the like. However, the human body sensor 17 is not so limited, but may be various sensors that detect a person by using various methods. Meanwhile, in the human body sensor 17, a range in which the person can be detected is determined based on a kind of the human body sensor 17, setting, or the like. In the following, the above-described range will be called as a “sensor detection range”.

The lamp 18 is, for example, an LED lamp, a rotary beacon light or the like. As described later, the lamp 18 is caused to blink or the like upon recovering from a power saving state of the image forming apparatus 10 or the like, and reports the user that the image forming apparatus 10 becomes usable. The image forming apparatus 10 may be provided with a buzzer or the like for reporting that the image forming apparatus becomes usable, for example, instead of the lamp 18 or in conjunction with the lamp 18.

The image processing engine 19 performs various image forming functions, such as a printing function, a copying function, a scanning function or the like, with which the image forming apparatus 10 is provided.

The image forming apparatus 10 according to the first embodiment can realize various processes, which will be described later, by the above-described hardware configuration. <Software Configuration>

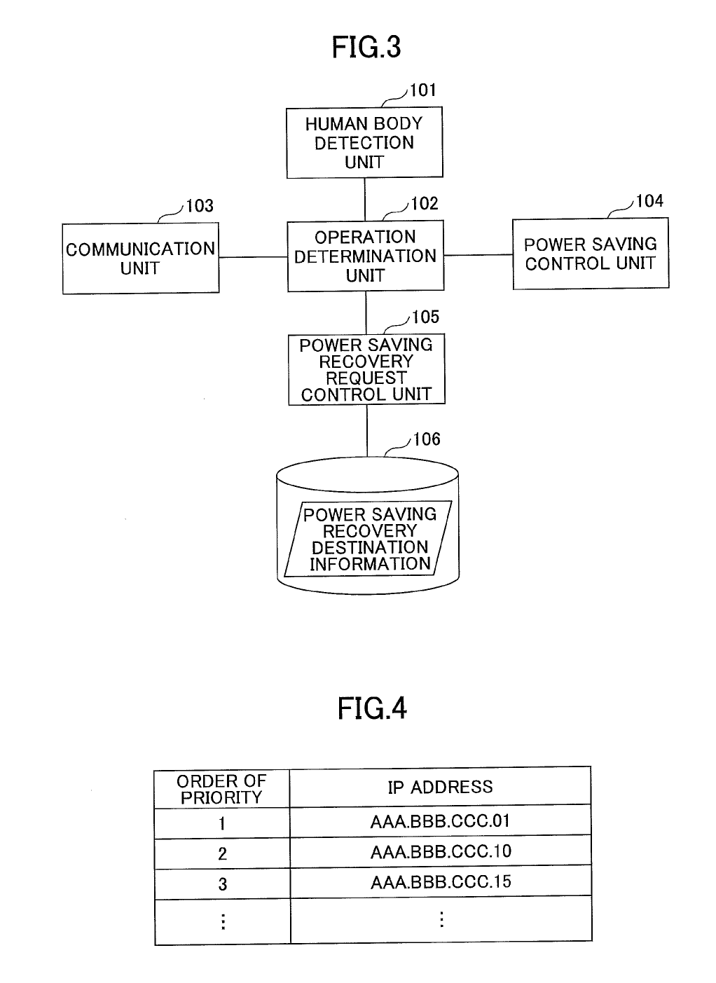

Next, a software configuration of the image forming apparatus 10 according to the first embodiment will be explained. The image forming apparatus 10 according to the first embodiment is realized according to a functional block diagram as shown in FIG. 3, for example. FIG. 3 is a functional block diagram illustrating an example of the image forming apparatus 10 according to the first embodiment. As shown in FIG. 3, the image forming apparatus 10 according to the first embodiment includes a human body detection unit 101, an operation determination unit 102, a communication unit 103, a power saving control unit 104, a power saving recovery request control unit 105, and the like. Moreover, the image forming apparatus 10 according to the first embodiment uses a power saving recovery destination information storage unit 106.

The human body detection unit 101 is realized by the CPU 11, the human body sensor 17 and the like, and detects a person existing in the sensor detection range. In the case of detecting a person in the sensor detection range, the human body detection unit 101 gives notice to the operation determination unit 102 that the person is detected. According to the above-described configuration, the image forming apparatus 10 can detect that a person (user) who desires to use the image forming apparatus 10 approaches.

The operation determination unit 102 is realized by the CPU 11 or the like, and determines whether the image forming apparatus 10 is running in a case where an approach of a person is detected by the human body detection unit 101. Here, the image forming apparatus 10 running means a case where a predetermined job is being executed at the image forming apparatus 10. It is a case where the scanning function, a plotting function or the like is being executed at the image processing engine 19 of the image forming apparatus 10. Moreover, it is a case where data are being sent/received via the communication I/F 15 of the image forming apparatus 10 or a case where software such as the OS or the like of the image forming apparatus 10 is being updated. That is to say, “running” refers to the state where the user cannot use the image forming apparatus 10 since some function is being executed. On the other hand, the image forming apparatus 10 not running refers to the power saving state (electric energy saving state) where a power supply to the operation panel 16, the image processing engine 19 or the like of the image forming apparatus 10 is restricted.

The communication unit 103 is, for example, realized by the CPU 11, the communication I/F 15 or the like, and performs communication with other image forming apparatuses 10.

The power saving control unit 104 is realized by the CPU 11 or the like, and performs control for recovering the image forming apparatus 10 from power saving state (electric energy saving state) in response to a request from the operation determination unit 102 or the like. That is, the power saving control unit 104 causes an operation state of the image forming apparatus 10 to transition from the power saving state to a state where a predetermined process is executable (i.e., recovery from power saving) by performing control for supplying power to the operation panel 16, the image processing engine 19 or the like in response to a request. Meanwhile, the predetermined process is a process related to image formation for realizing the printing function, the copying function, the scanning function or the like, which is realized according to the above-described image processing engine 19. That is, the process related to the image formation includes a printing process for realizing the printing function, a copying process for realizing the copying function, a scanning process for realizing the scanning function, or the like.

Here, the above-described operation state is information indicating in what condition the image forming apparatus 10 operates. The operation state includes a state where the power supply to the image processing engine 19 or the like is restricted (power saving state) as described above, a state where such restriction for the power supply is not performed (state recovered from the power saving), or the like. Moreover, the operation state may include various states, such as a state where power is not supplied to the whole image forming apparatus 10 (power off state), a state where only a predetermined function (for example, the copying function) is executable, or the like.

The power saving recovery request control unit 105 is realized by the CPU 11 or the like, and acquires an IP address of an image forming apparatus 10, which is to recover from the power saving state, from the power saving recovery destination information storage unit 106 in response to a request from the operation determination unit 102 or the like.

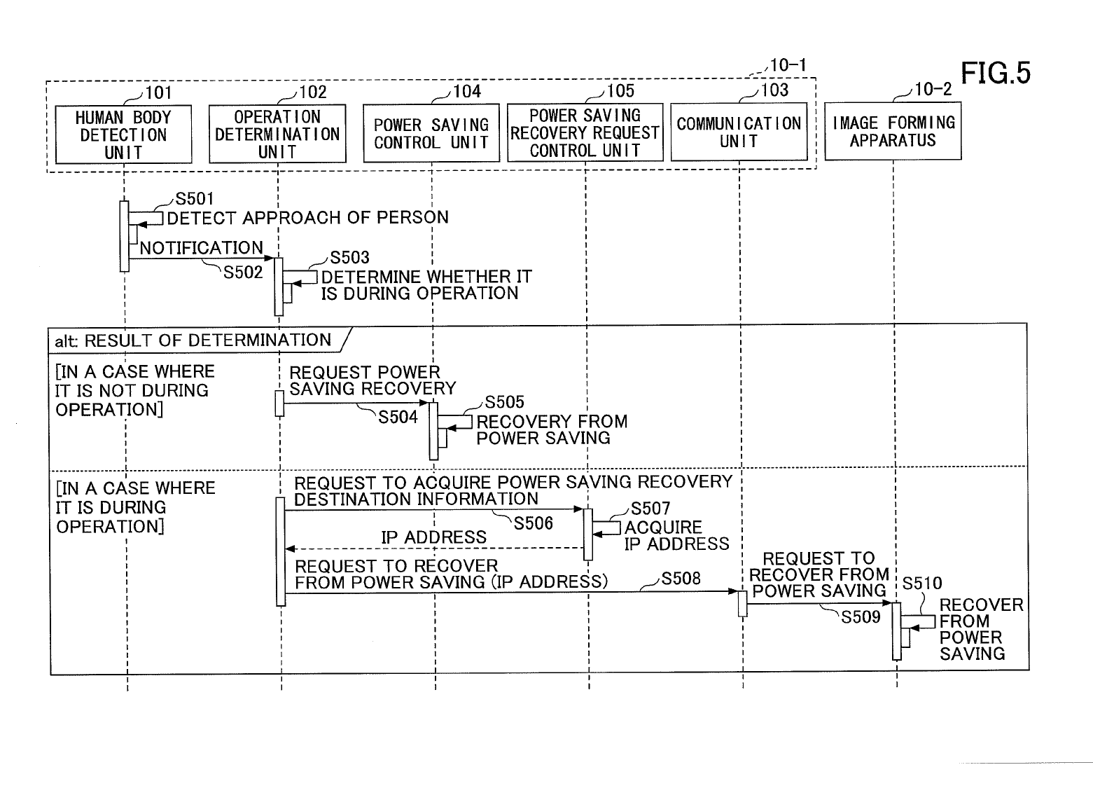

The power saving recovery destination information storage unit 106 is realized by the HDD 14, a storage device connected to the image forming apparatus 10 via the network N1, or the like, and stores power saving recovery destination information. The power saving recovery destination information is information indicating an image forming apparatus 10 which transitions from the power saving state to a state where a predetermined process is executable (recovery from power saving), and has a data configuration, as shown in FIG. 4, for example. FIG. 4 is a diagram for explaining an example of the power saving recovery destination information.

The power saving recovery destination information, shown in FIG. 4, includes data items such as order of priority, an IP address or the like. The order of priority is information indicating an order of priority of the image forming apparatuses 10, which are to recover from the power saving state. The IP address is address information indicating the image forming apparatus 10 which is to recover from the power saving state. According to the above-described configuration, the image forming apparatus 10 sends a request for recovering another image forming apparatus 10 from power saving according to the order of priority, in a case where the operation determination unit 102 determines that the own image forming apparatus 10 is running.

Meanwhile, the power saving recovery destination information may retain different content for each image forming apparatus 10. In this case, the order of priority is preferably made higher for other image forming apparatuses 10 installed close to the own image forming apparatus. On the other hand, the order of priority is preferably made lower for other image forming apparatuses 10 installed apart from the own image forming apparatus 10. Furthermore, the address information indicating the image forming apparatus 10 which is to recover from the power saving state is not limited to an IP address, but a physical address such as a MAC (Media Access Control) address, a production specific number (serial number), or the like may be used.

<Details of Process>

Next, details of processes of the image processing system 1 according to the first embodiment will be explained. In the image processing system 1 according to the first embodiment, the image forming apparatus 10 detects an approach of a user in a case where the user approaches the image forming apparatus 10 in order to use the image forming apparatus 10. Then, the image forming apparatus 10 determines whether the own apparatus is during an operation, and causes either of the own apparatus or another image forming apparatus 10 to recover from power saving depending on a result of the determination. Moreover, in the case where the other image forming apparatus 10 recovers from power saving, the other image forming apparatus 10 causes, for example, the lamp 18 or the like to blink in order to guide the user to the other image forming apparatus 10.

A recovery process from power saving of the image processing system 1 according to the first embodiment, as described above, will be explained in detail as follows. FIG. 5 is a sequence diagram illustrating an example of the recovery process from power saving according to the first embodiment. In the following, the image forming apparatus 10, which the user approaches in order to use, will be referred to as an “image forming apparatus 10-1”, and the other image forming apparatus 10 will be referred to as an “image forming apparatus 10-2”.

The human body detection unit 101 of the image forming apparatus 10-1 detects an approach of a person (step S501). That is, in a case where the user desires to use the image forming apparatus 10-1, approaches the image forming apparatus 10-1 and enters a sensor detection range, the human body detection unit 101 of the image forming apparatus 10-1 detects the user.

The human detection unit 101 of the image forming apparatus 10-1 reports the operation determination unit 102 of the detection of the approach of the person (step S502).

The operation determination unit 102 of the image forming apparatus 10-1 determines whether the image forming apparatus 10-1 is performing an operation (step S503). Here, the image forming apparatus 10-1 performing an operation means, as described above, a case where a predetermined job is being executed at the image forming apparatus 10-1. In the case where the predetermined job is being executed at the image forming apparatus 10-1, the user cannot use the image forming apparatus 10-1. Therefore, the above operation can be rephrased as determination whether the user can use the image forming apparatus 10-1.

The image forming apparatus 10-1 executes processes of steps S504 to S505 or processes of steps S506 to S508 depending to a result of determination of the operation determination unit 102. That is, in the case where the operation determination unit 102 determines that the image forming apparatus 10-1 is not performing an operation, the image forming apparatus 10-1 executes the processes of steps S504 to S505. On the other hand, in the case where the operation determination unit 102 determines that the image forming apparatus 10-1 is performing an operation, the image forming apparatus 10-1 executes the processes of steps S506 to S508.

The operation determination unit 102 of the image forming apparatus 10-1 performs a power saving recovery request for the power saving control unit 104 in order to cause the image forming apparatus 10-1 to recover from power saving (step S504).

The power saving control unit 104 of the image forming apparatus 10-1, upon receiving the power saving recovery request from the operation determination unit 102, causes the image forming apparatus 10-1 to recover from power saving (step S505). That is, the power saving control unit 104 causes the image forming apparatus 10-1 to transition from a power saving state to a state in which a predetermined process can be executed. According to the above operation, the user can use the image forming apparatus 10-1.

Furthermore, such power saving recovery is performed by the user entering the sensor detection range of the image forming apparatus 10-1 and the human body detection unit 101 detecting the user. Therefore, upon the user arriving in front of the operation panel 16 of the image forming apparatus 10-1, the image forming apparatus 10-1 has already recovered from power saving, and the user can start an operation for the image forming apparatus 10-1 promptly without waiting.

The operation determination unit 102 of the image forming apparatus 10-1 requires the power saving recovery request control unit 105 to acquire power saving recovery destination information (step S506).

The power saving recovery request control unit 105 of the image forming apparatus 10-1, upon receiving a request to acquire power saving recovery destination information from the operation determination unit 102, acquires an IP address in accordance with an order of priority from power saving recovery destination information stored in the power saving recovery destination information storage unit 106 (step S507). That is, the power saving recovery request control unit 105 acquires an IP address with the highest order of priority from the power saving recovery destination information (for example, the IP address “AAA.BBB.CCC.01” with the order of priority of “1” in FIG. 4). Then, the power saving recovery request control unit 105 returns the acquired IP address to the operation determination unit 102. Here, the acquired IP address is assumed to be an IP address indicating the image forming apparatus 10-2, and will be used in the following explanation.

The operation determination unit 102 of the image forming apparatus 10-1, upon receiving the IP address from the power saving recovery request control unit 105, transmits a power saving recovery request including the received IP address to the communication unit 103 (step S508).

The communication unit 103 of the image forming apparatus 10-1, upon receiving the power saving recovery request from the operation determination unit 102, transmits the power saving recovery request to the IP address included in the power saving recovery request (in this case, the image forming apparatus 10-2) (step S509). The image forming apparatus 10-2, upon receiving the power saving recovery request from the image forming apparatus 10-1, causes the own apparatus to recover from power saving (step S510). That is, at the image forming apparatus 10-2, the processes of steps S501 to S505, as described above, are performed.

Moreover, at this time, the image forming apparatus 10-2, upon the own apparatus being caused to recover from power saving, causes the lamp 18 or the like to blink or the like by a state notification unit (not shown) to guide the user. That is, the image forming apparatus 10-2 reports the user or the like of the own operation state, which recovers from power saving, by blinking or the like of the lamp 18 or the like. According to the above-described configuration, in the case where the image forming apparatus 10-1 is unavailable since it is performing an operation, the user can use the other image forming apparatus 10-2. Therefore, the user need not wait until the image forming apparatus 10-1 becomes available, and can use promptly the other image forming apparatus 10-2.

Meanwhile, at step 5510, described as above, in the case where the image forming apparatus 10-2 is performing an operation, the image forming apparatus 10-2 may return information indicating that the own apparatus is performing an operation to the image forming apparatus 10-1. In this case, the image forming apparatus 10-1, upon receiving the information indicating that the image forming apparatus 10-2 is performing an operation, acquires an IP address of an image forming apparatus 10 of the next order of priority from the power saving recovery destination information stored in the power saving recovery destination information storage unit 106. Then, a power saving recovery request has only to be sent to the image forming apparatus 10 indicated by the acquired IP address.

### Second Embodiment

Next, a system configuration of an image processing system 1 according to a second embodiment will be explained. Difference from the first embodiment is that the respective image forming apparatuses 10 possess information indicating an image forming apparatus 10 which has already recovered from power saving among the plural image forming apparatuses 10. Meanwhile, in the following, for a part having essentially the same function as the first embodiment and for a part performing the same process, the same reference numeral as in the first embodiment is used, and an explanation thereof will be omitted.

<Software Configuration>

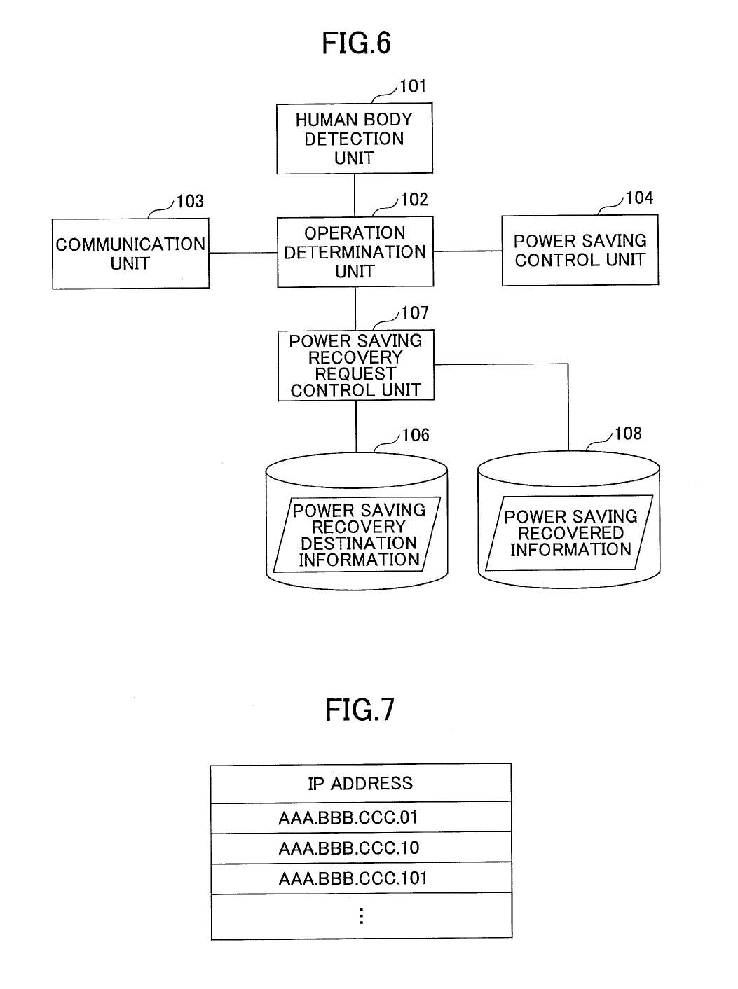

Next, a process of the image processing system 1 according to the second embodiment will be explained in detail. The image processing system 1 according to the second embodiment, different from the first embodiment, further includes a power saving recovered information storage unit 108 (see FIG. 6) for storing power saving recovered information indicating the image forming apparatus 10 which has recovered from power saving, and the power saving recovery request control unit 107 determines the image forming apparatus 10, which is to be caused to recover from power saving, based on the power saving recovered information. Meanwhile, the other functional blocks are the same as those in the first embodiment, and explanations thereof will be omitted.

The power saving recovery request control unit 107, upon acquiring the IP address of the image forming apparatus 10, which is to be caused to recover from power saving, from the power saving recovery destination information storage unit 106, acquires an IP address of an image forming apparatus 10 which has not returned from power saving, referring to the power saving recovered information storage unit 108.

The power saving recovered information storage unit 108 is realized by a storage medium or the like connected to the HDD 14 or the image forming apparatus 10 via the network N1, and stores power saving recovered information. The power saving recovered information is information (for example, an IP address or the like) indicating an image forming apparatus 10 which has already recovered from power saving, and has a data configuration as shown in FIG. 7, for example. FIG. 7 is a diagram for explaining an example of the power saving recovered information.

The power saving recovered information, as shown in FIG. 7, is a list of IP addresses of image forming apparatuses 10 which have already recovered from power saving. According to the above-described configuration, each of the image forming apparatuses 10 can determine which image forming apparatus 10 recovers from power saving. Therefore, as explained in a process which will be described later, in the case where the image forming apparatus 10, which a user desires to use, is performing an operation, it is possible to guide the user so as to use another image forming apparatus 10, which has not recovered from power saving. Meanwhile, the reason for guiding the user so as to use the other image forming apparatus which has not recovered from power saving is that an image forming apparatus 10 which already has recovered from power saving has higher probability to already be performing an operation.

The power saving recovered information, explained as above, may be prepared by, for example, upon the image forming apparatus 10 detecting an approach of a person, generating an empty list to be formed in the power saving recovered information storage unit 108. Moreover, the prepared power saving recovered information is preferably arranged so that the list is cleared (all IP addresses in the list are removed) at a predetermined timing (for example, a predetermined time elapses). This is because the image forming apparatus 10 which has recovered from power saving transitions to a power saving state again in a case where a predetermined time elapses in a non-operation state.

<Details of Process>

Next, details of processes of the image processing system 1 according to the second embodiment will be explained. In the image processing system 1 according to the second embodiment, the image the image forming apparatus 10 detects an approach of a user in a case where the user approaches the image forming apparatus 10 in order to use the image forming apparatus 10. Then, the image forming apparatus 10 determines whether the own apparatus is performing an operation, and causes either of the own apparatus or another image forming apparatus 10 to recover from power saving depending on a result of determination. Moreover, in the case where the other image forming apparatus 10 recovers from power saving, the other image forming apparatus 10 causes, for example, the lamp 18 or the like to blink in order to guide the user to the other image forming apparatus 10.

Upon causing the other image forming apparatus 10 to recover from power saving depending on the above-described result of determination, in the second embodiment, an image forming apparatus, which is not stored in the power saving recovered information and has the highest order of priority in the power saving recovery destination information, is caused to recover from power saving.

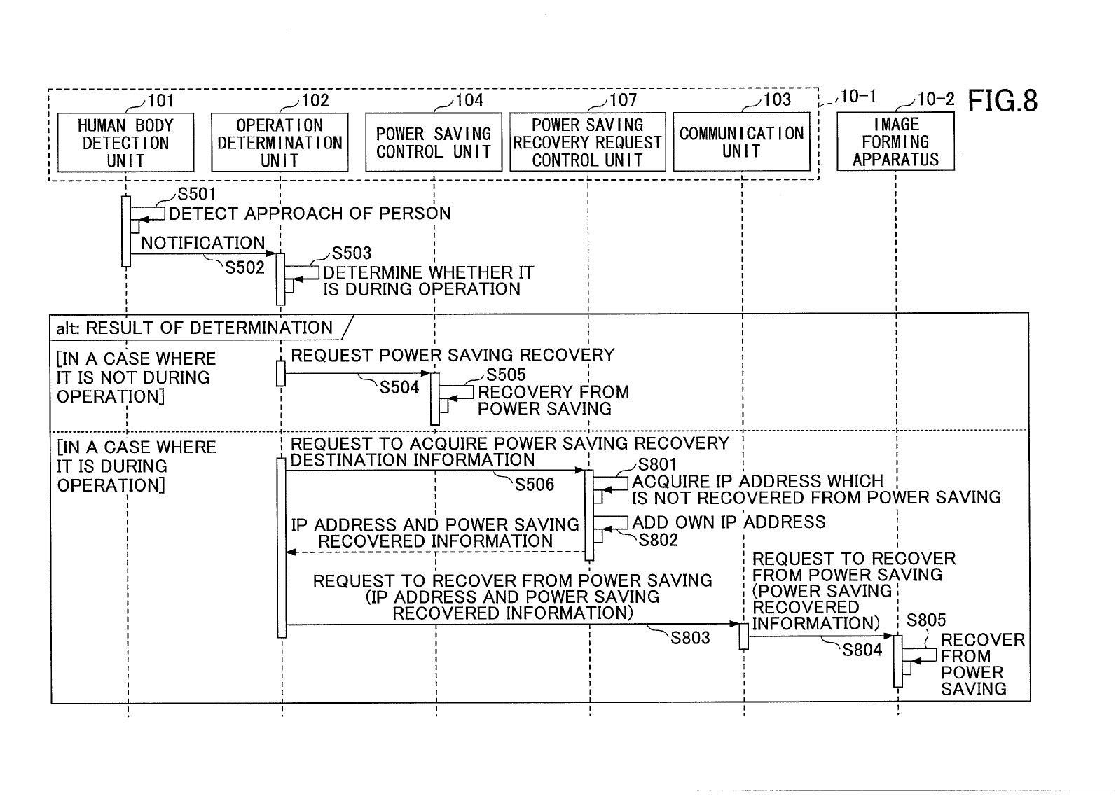

A recovery process from power saving of the image processing system 1 according to the second embodiment, as described above, will be explained in detail as follows. FIG. 8 is a sequence diagram illustrating an example of the recovery process from power saving according to the second embodiment. Meanwhile, in the recovery process from power saving of the image processing system 1 according to the second embodiment, processes at steps S801 to S805 are different from those in the recovery process from power saving of the image processing system 1 according to the first embodiment. Therefore, only the processes at steps S801 to S805 will be explained, and an explanation of processes at other steps will be omitted.

The power saving recovery request control unit 107 of the image forming apparatus 10-1, upon receiving a request to acquire power saving recovery destination information from the operation determination unit 102, acquires an IP address in accordance with an order of priority from power saving recovery destination information stored in the power saving recovery destination information storage unit 106, while referring to the power saving recovered information (step S801). That is, the power saving recovery request control unit 107 performs processes (1) to (3) as follows:

(1) acquiring an IP address of an image forming apparatus 10 with the highest order of priority from the power saving recovery destination information stored in the power saving recovery destination information storage unit 106;

(2) determining whether the acquired IP address exists in the power saving recovered information stored in the power saving recovered information storage unit 108; and

(3) proceeding to next step S802, in a case where the acquired IP address does not exist in the power saving recovered information, as a result of the determination at above-described (2). On the other hand, in a case where the acquired IP address exists in the power saving recovered information, as the result of the determination at above-described (2), an IP address with the second-highest order of priority is acquired from the power saving recovery destination information, and the process returns to above-described (2).

Meanwhile, as a result of the processes (1) to (3), in a case where all the IP addresses of the power saving recovery destination information exist in the power saving recovered information, the power saving recovery request control unit 107 clears the power saving recovered information (all the IP addresses in the list are removed). Then, the power saving recovery request control unit 107 acquires an IP address of an image forming apparatus 10 with the highest order of priority from the power saving recovery destination information.

According to the process at step S801, explained as above, it becomes possible to guide a user so as to use another image forming apparatus 10, which has not yet recovered from power saving, in a the case where an image forming apparatus 10, which the user desired to use, is performing an operation. Therefore, in the image processing system 1, as a whole, image forming apparatuses 10 which the respective users use are controlled so as to be dispersed. Accordingly, wait time for users using the image processing system 1 is reduced as a whole.

The power saving recovery request control unit 107 of the image forming apparatus 10-1 adds an IP address of the own apparatus (here, the IP address of the image forming apparatus 10-1) to the power saving recovered information (step S802). Then, the power saving recovery request control unit 107 returns the above-described IP address acquired at step S801 and the power saving recovered information following, the above-described IP address acquired at step 5801 is assumed to be an IP address indicating an image forming apparatus 10-2, and will be explained in the following.

The operation determination unit 102 of the image forming apparatus 10-1, upon receiving the IP address and the power saving recovered information from the power saving recovery request control unit 107, transmits a power saving recovery request including the received IP address and the power saving recovered information to the communication unit 103 (step S803).

The communication unit 103 of the image forming apparatus 10-1, upon receiving the power saving recovery request from the operation determination unit 102, transmits the power saving recovery request to an IP address (here, the image forming apparatus 10-2), which is included in the power saving recovery request (step S804).

The image forming apparatus 10-2, upon receiving the power saving recovery request from the image forming apparatus 10-1, causes the own apparatus to recover from power saving (step S805). That is, at the image forming apparatus 10-2, the processes at steps S501 to S505, which are explained with reference to FIG. 5, are performed.

Moreover, at this time, the image forming apparatus 10-2, upon the own apparatus being caused to recover from power saving, causes the lamp 18 or the like to blink or the like by a state notification unit (not shown) to guide the user. That is, the image forming apparatus 10-2 reports the user or the like of the own operation state, which recovers from power saving, by blinking or the like of the lamp 18 or the like.

Furthermore, the image forming apparatus 10-2 updates the power saving recovered information storage unit 108 of the image forming apparatus 10-2 based on the power saving recovered information included in the power saving recovery request which is received from the image forming apparatus 10-1. According to the above-described operation, information on an image forming apparatus 10 which has recovered from power saving is shared between the image forming apparatus 10-1 and the image forming apparatus 10-2 (especially, the image forming apparatus 10-2 can recognize that the image forming apparatus 10-1 has recovered from power saving).

In the image processing system 1 according to the second embodiment, described as above, by each of the image forming apparatuses 10 having address information indicating an image forming apparatus 10 which has recovered from power saving, it is possible to guide a user effectively to another image forming apparatus 10 which has not recovered from power saving. Therefore, for a user of the image processing system 1 according to the second embodiment, in addition to the reduction of the wait time till when another available image forming apparatus 10 recovers from power saving, wait time till when the user is guided to this other image forming apparatus 10 is also reduced.

<Summary>

As described above, in the image processing system 1 according to the first embodiment, in the case where a user approaches an image forming apparatus 10 in order to use the image forming apparatus 10, the image forming apparatus 10 detects approach of the user. Then, the image forming apparatus 10 determines whether the own apparatus is performing an operation, and causes either of the own apparatus or another image forming apparatus 10 to recover from power saving depending on a result of the determination. Moreover, in the case where the other image forming apparatus 10 recovers from power saving, the other image forming apparatus causes the lamp 18 or the like to blink or the like in order to guide the user to the other image forming apparatus 10. According to the above-described configuration, the user of the image processing system 1 according to the first embodiment, in either of the case of using the image forming apparatus 10, which the user approaches first, or the case of using the image forming apparatus 10 to which the user is guided, can promptly start to use without waiting for power saving recovery.

Moreover, in the image processing system 1 according to the second embodiment by each of the image forming apparatuses 10 having information indicating an image forming apparatus 10 which has recovered from power saving, wait time till when the user is guided to the other image forming apparatus 10 is reduced.

Meanwhile, the human body unit 101 is an example of a human detection unit. The operation determination unit 102 is an example of a process determination unit. The operation determination unit 102, the communication unit 103 and the power saving control unit 104 are an example of a state transition unit. The power saving recovery destination information storage unit 106 is an example of a first storage unit. The power saving recovered information storage unit 108 is an example of a second storage unit.

Further, the present invention is not limited to these embodiments, but various variations and modifications may be made without departing from the scope of the present invention.

The present application is based on and claims the benefit of priority of Japanese Priority Application No. 2014-198512 filed on Sep. 29, 2014, the entire contents of which are hereby incorporated by reference.

What is claimed is:

1. An information processing system, including a plurality of image processing apparatuses which are connected with each other via a network, the information processing system comprising:
a human detection unit configured to detect a person within a predetermined range from an image processing apparatus of the plurality of image processing apparatuses;
a process determination unit configured to determine whether the image processing apparatus is performing execution of a predetermined process, in a case where the human detection unit detects the person within the predetermined range; and
a state transition unit configured to require another image processing apparatus of the plurality of image processing apparatuses, which is different from the image processing apparatus, to cause an operation state of the other image processing apparatus to transition to a state in which the predetermined process can be executed, in a case where the process determination unit determines that the image processing apparatus is performing execution of the predetermined process.

2. The information processing system as claimed in claim 1, wherein the state transition unit is configured to cause an operation state of the image processing apparatus to transition to a state in which the predetermined process can be executed, in a case where the process determination unit determines that the image processing apparatus is not performing execution of the predetermined process.

3. The information processing system as claimed in claim 2, wherein the state transition unit is configured to require the other image processing apparatus to cause the operation state of the other image processing apparatus to recover from a power saving state, in the case where the process determination unit determines that the image processing apparatus is performing execution of the predetermined process, and wherein the state transition unit is configured to cause the operation state of the image processing apparatus to recover from the power saving state, in the case where the process determination unit determines that the image processing apparatus is not performing execution of the predetermined process.

4. The information processing system as claimed in claim 3, further comprising a first storage unit configured to store an order of priority for transitions of operation states of the plurality of image processing apparatuses, wherein the state transition unit is configured to require, in accordance with the order of priority stored in the first storage unit, the other image processing apparatus to cause the operation state of the other image processing apparatus to recover from the power saving state, in the case where the process determination unit determines that the image processing apparatus is performing execution of the predetermined process.

5. The information processing system as claimed in claim 3, further comprising a second storage unit configured to store information indicating a recovered image processing apparatus of the plurality of image processing apparatuses, an operation state of the recovered image processing apparatus having recovered from the power saving state, wherein the state transition unit is configured to require the other image processing apparatus, which is not indicated by the information stored in the second storage unit, to cause the operation state of the other image processing apparatus to recover from the power saving state, in the case where the process determination unit determines that the image processing apparatus is performing execution of the predetermined process.

6. The information processing system as claimed in claim 1, wherein the predetermined process is any one of a print process, a copy process and a scan process.

7. The information processing system as claimed in claim 1, further comprising a state notification unit configured to report the operation state of the image processing apparatus or the other image processing apparatus, the state transition unit causing the operation state to transition.

8. An image processing apparatus connected with another image processing apparatus via a network, comprising:
a human detection unit configured to detect a person within a predetermined range from the image processing apparatus;
a process determination unit configured to determine whether the image processing apparatus is performing execution of a predetermined process, in a case where the human detection unit detects the person within the predetermined range; and
a state transition unit configured to require the other image processing apparatus to cause an operation state of the other image processing apparatus to transition to a state in which the predetermined process can be executed, in a case where the process determination unit determines that the image processing apparatus is performing execution of the predetermined process.

9. An information processing method in an image processing apparatus connected with another image processing apparatus via a network, the method comprising:
detecting a person within a predetermined range from the image processing apparatus;
determining whether the image processing apparatus is performing execution of a predetermined process, in a case where the person is detected within the predetermined range; and
requiring the other image processing apparatus to cause an operation state of the other image processing apparatus to transition to a state in which the predetermined process can be executed, in a case where the image processing apparatus is determined to be performing execution of the predetermined process.
